(19) United States
(12) Patent Application Publication
(10) Pub. No.: US 2007/0133665 A1
(43) Pub. Date: Jun. 14, 2007

(54) Network aware mobile devices and operations

(76) Inventor: Louis Robert Litwin, Plainsboro, NJ (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/577,294

(22) PCT Filed: Nov. 5, 2003
(86) PCT No.: PCT/US03/35492

§ 371 Date: Apr. 29, 2006

(51) Int. Cl. H04L 5/16

(52) U.S. Cl. 375/219

(57) ABSTRACT

A network aware mobile device (12) includes a transceiver, which identifies one of a plurality of networks (18,20,22) with which the transceiver can communicate. Memory stores information associating networks with operations, which can be performed using the transceiver. Operations are executed when communication with one of the plurality of networks is permitted.

### FIELD OF THE INVENTION

The present invention generally relates to network communications and, more particularly, to a method and apparatus for providing network aware devices and services related thereto.

### BACKGROUND OF THE INVENTION

A recent trend in mobile devices includes creating devices capable of communicating over multiple networks. In one example, mobile devices may be capable of communicating over both cellular and WLAN (wireless LAN) networks. Cellular coverage is widely available, but airtime is expensive. WLAN access is typically only available near WLAN hotspots, but the airtime is much cheaper. It would be advantageous to have a system and method, which permits a mobile device to base certain operations or services on the type of network that the device is currently accessing.

### SUMMARY OF THE INVENTION

A network aware mobile device includes a transceiver, which identifies one of a plurality of networks with which the transceiver can communicate. Memory stores information associating networks with operations, which can be performed using the transceiver. Operations are executed when communication with one of the plurality of networks is permitted.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is an illustrative diagram showing a mobile unit moving between networks and the results of initiating communications with each network in accordance with the present invention;

FIG. 2 is a block diagram showing components of an illustrative mobile unit in accordance with one embodiment of the present invention; and

FIG. 3 is a flow diagram showing a method for employing a network aware device in accordance with the present invention.

It should be understood that the drawings are for purposes of illustrating the concepts of the invention and are not necessarily the only possible configuration for illustrating the invention.

### DETAILED DESCRIPTION OF THE INVENTION

The present invention provides a method and apparatus, which permits a mobile device to sense a type of network that the mobile device is communicating on (e.g., WLAN, cellular) and conducts operations based on the network type. In one embodiment, a user employs a mobile device to manually check what type of network the user is currently on. The device may also automate the process for the user and may perform actions as soon as the device is on a certain network, instead of the user having to constantly check the network status.

It is to be understood that the present invention is described in terms of a mobile phone system; however, the present invention is much broader and may include any multimedia or telecommunication device, which is capable of communications over multiple networks. It should be also understood that the elements shown in the FIGS. may be implemented in various forms of hardware, software or combinations thereof. Preferably, these elements are implemented in hardware on one or more appropriately programmed general-purpose devices, which may include a processor, memory and input/output interfaces.

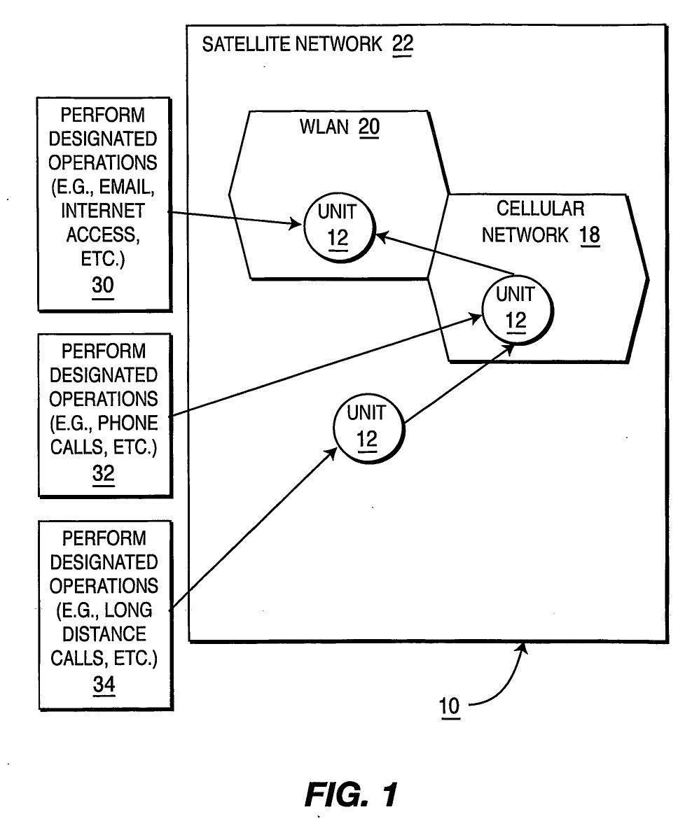

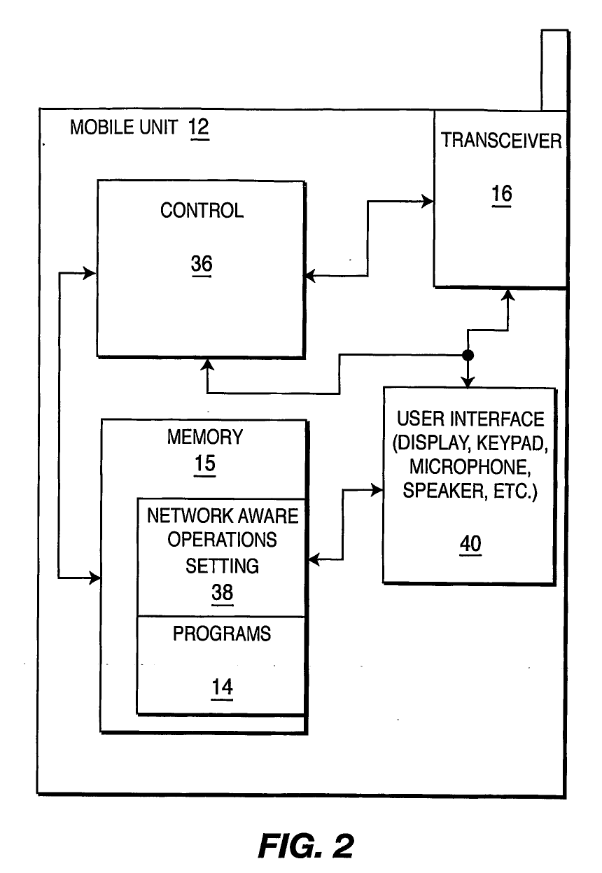

Referring now in specific detail to the drawings in which like reference numerals identify similar or identical elements throughout the several views, and initially to FIGS. 1 and 2, a mobile system 10 having network aware mobile units is illustratively shown in accordance with the present invention. The present invention provides at least one mobile unit 12, which may include a cellular telephone, a personal digital assistant (PDA), a wireless portable computer or other mobile telecommunications device. Unit 12 may include a program 14 stored in memory 15 and a transceiver 16, which receives information from one or more networks 18, 20 or 22, in this example, to provide an update as to an associated access point for a wireless local area network, cell site from a cellular network or satellite equipment for a satellite network. Transceiver 16 is adapted to communicate with a plurality of different networks, e.g., cellular 18, WLAN 20 or satellite (22) networks.

In one embodiment, unit 12 interrogates a nearby network by sending a plurality of different signals. Each signal is associated with available network types. For example, a cell signal, a WLAN signal and a satellite signal may be sent. The nearest networks could then respond to the interrogation signal. Unit 12 may, based on the signal strengths, choose a network to use or if many networks are available select a network to use based on the types and number of operations to be performed.

Referring to FIG. 1, for example, when a user tries to make a phone call from a mobile device as indicated in block 32, it may be desired that the call be processed immediately. In such case, the cellular network 18 would be best suited to meet the user's need. Certain operations which are not as time-critical, for example, operations such as checking or sending email, or downloading news, weather, stock quotes, or multimedia data such as audio/video, do not necessarily need to be performed immediately. Waiting to enter a WLAN 20 may be the cheapest and best solution in this case as indicated in block 30. The present invention takes advantage of this to perform the operations in a manner that reduces the user's airtime fees and increases performance. Other operations such as long distance calls or other operations, as indicated in block 34 may be performed in other networks, for example a satellite network 22.

Referring to FIG. 2, unit 12 preferably performs operations that the user can configure for network-aware use. Program 14 may provide the functionality to enter information into memory 15 for network aware operations settings 38. Network aware operations settings may include a table or other graphical user interface (GUI), which permits relationships between functions of unit 12 and available network options. For example, a user may choose to send email when a WLAN is available, select to use a satellite link for long distance calls and/or use a cell network when a call needs to be placed immediately. Other operations may be associated with these or other network types. Network aware operations settings 38 may employ unit 12 features to notify a user that information related to a selected user operation is available for retrieval. This will be explained in greater detail below.

The user can configure certain operations (such as in the above examples) to be network-aware by employing a user interface 40. User interface 40 may include a plurality of different arrangements depending on the device and its needed functions. Interface 40 may include a display, keypad or keyboard, microphone, speaker or any other suitable input/output interface. If an operation is classified as being network-aware, the mobile device will only perform the operation when a certain type of network is being accessed. Since WLAN airtime rates are usually cheaper than cellular airtime rates, a preferred embodiment of this invention would only perform certain operations when the device or unit 12 was communicating with a WLAN 20. The present invention could be extended such that operations would only be performed when the device is accessing a particular WLAN (e.g., one that the user has an account with, or one with airtime rates below a user-defined threshold, etc.).

In another embodiment, the networks (18, 20 and/or 22) constantly or periodically identify themselves by sending out a signal or packet. By identifying themselves, mobile unit 12 needs to receive these signals and may correspond directly with the appropriate network with a predetermined task. A control module 40 controls interactions between components/functions of unit 12. Control module 40 may include one or more processors for executing operations and device functions in unit 12.

If the user selects to perform a network-aware operation, the device will first check to see what type of network it is communicating with. Depending on the user settings, network aware operations will be performed from the user's mobile device only if the appropriately associated network is available. If the operation is not urgent and the user is on a cellular network, the mobile device may not perform the operation immediately. Instead, the device will detect when the user enters, for example, a WLAN hotspot region. Once a WLAN is detected, the device will turn on its WLAN radio and connect with the WLAN network. At that point, it will perform the user's requested operation. Because of cheaper WLAN airtime rate, cost savings result.

Another embodiment includes a feature (38) that the user can be alerted that he has an email, etc. similar to the way that phones currently alert or notify the user about, for example, a voicemail, email or multimedia file, etc. This alert would not need to use any cellular airtime. At this point, the device would not yet download the email. The user can then walk near a WLAN hotspot and the device would then download the email via the WLAN network.

Another embodiment performs the operations when on a particular type of network is available, say a particular WLAN, for example, one that the user has an account with, or one with an airtime rate below a certain level, etc. The mobile device may alert the user that email is available (or other incoming information) using a method similar to how current cell phones inform the user that they have voicemail waiting (however, the user need not be charged cellular airtime for this). The user can then enter a WLAN hotspot to download the information.

Operations selected to be performed by unit 12 are executed by the appropriate hardware/software of the device. This hardware/software may include appropriate protocol stacks and security measures needed for network communications.

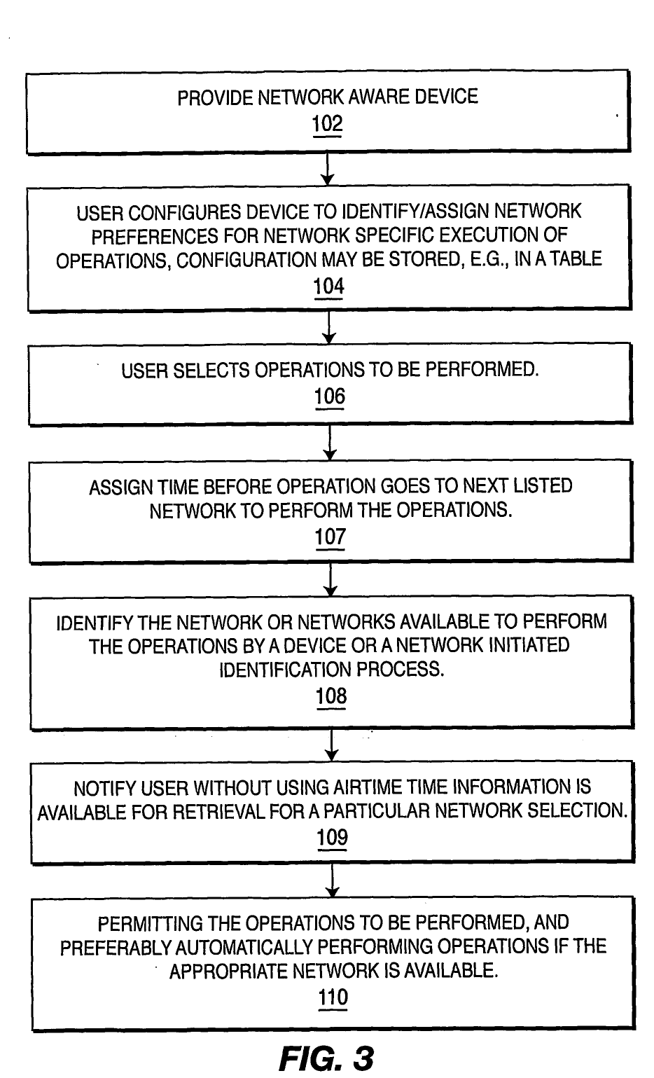

Referring to FIG. 3, a method for employing a network aware mobile device is illustratively described. In block 102, a network aware device is provided. The network aware device may include a cellular phone, PDA, laptop computer or the like. The network aware device includes the capability to decipher networks, which are available for use. This may be performed by a device initiated or a network initiated process. In block 104, the user configures the mobile device to provide default networks for which predefined operations of the device are performed. Certain operations on the mobile device can be classified as network-aware. These operations will only be performed by device when the device is communicating with a particular type of network such as a WLAN. In block 106, the user selects an operation or operations to be performed.

Table 1 illustrates an exemplary method of associating operations with networks. Networks may be ranked to provide preferences. One or more network types may be assigned to each operation. Elapsed times may be assigned such that if the amount of time elapses, the next network is employed to perform the operation.

TABLE 1

| | FIRST | SECOND | ELAPSED |
|---|---|---|---|
| OPERATION | NETWORK | NETWORK | TIME |
| Telephone Call | Cellular | Cellular | 0 min |
| Email | WLAN | Cellular | 120 min |
| Internet access | HOME WLAN | OTHER WLAN | 20 min |
| Long distance calls | Cellular | Satellite | 5 min |

In an optional embodiment, user preferences may be ranked and/or assigned a time for execution. If the first available choice of networks is not available for an assigned period of time a next ranked network is used to execution the pending operation or operations, in block 107. In block 108, the mobile device identifies the network, which it is on, or the networks available to the device on which to perform the device operations. The operation to be performed may include notifying a user, in block 109, that information is available for retrieval from a network selected by the user as a network preference for that operation of operations. When the user enters that network the operation of which he was notified will be performed automatically to retrieve the information. The automatic retrieval may be in accordance with networks in an order of priority such that if a first network is unavailable a next network is employed to perform the operation (see block 110 below).

If the appropriate network is available, the mobile device will automatically perform the operations selected by the user in block 110. The mobile device automatically performs the operation upon detecting the appropriate network. No user intervention is needed or required.

Having described preferred embodiments for network aware mobile devices and operations (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A network aware mobile device, comprising:
a transceiver, which identifies one of a plurality of networks with which the transceiver can communicate;
memory which stores information associating networks with operations which can be performed using the transceiver; and
means for executing the operations when communication with one of the plurality of networks is permitted.

2. The device as recited in claim 1, wherein the transceiver is included in one of a telephone, a personal digital assistant, and a portable computer.

3. The device as recited in claim 1, wherein the plurality of networks includes one or more of a wireless local area network and a cellular network.

4. The device as recited in claim 1, wherein the memory stores a user-programmable table, which associates transceiver operations with network preferences.

5. The device as recited in claim 1, wherein the means for executing includes automatic execution of the operations.

6. The device as recited in claim 1, further comprising a function for determining an identity of a network connected to the mobile device.

7. The device as recited in claim 1, wherein the memory includes a list of network preferences associated with one or more operations and further including an associated time such that if the associated time elapses a next network preference is employed to perform the operation.

8. The device as recited in claim 1, further comprising a notification feature which notifies a user that information is available for download, wherein the information is automatically downloaded when communication is established with a network selected by the user.

9. The device as recited in claim 8, wherein the network selected by the user is selected from a list of network preferences associated with one or more operations and further including an associated time such that if the associated time elapses a next network preference is employed to perform the operation.

10. A method for operating a network aware mobile device, comprising the steps of:
providing a device that is aware of a network in which the device is located;
configuring the device to perform a selected operation in a predetermined network;
when the predetermined network can be communicated with, permitting the operation to be performed.

11. The method as recited in claim 10, wherein the step of configuring the device includes assigning operations to networks.

12. The method as recited in claim 11, wherein the step of assigning operations to networks includes storing operation assignments in a table.

13. The method as recited in claim 11, wherein the step of assigning includes assigning networks to operations in an order of priority such that if a first network is unavailable a next network is employed to perform the operation.

14. The method as recited in claim 10, wherein the step of permitting the operation to be performed includes automatically performing the operation once communications with an appropriately selected network have been established.

15. The method as recited in claim 10, further comprising the step of identifying the network or networks that the device is in.

16. The method as recited in claim 15, wherein the step of identifying the network or networks includes identifying the network the device is in by signaling networks to identify themselves.

17. The method as recited in claim 15, wherein the step of identifying the network or networks includes identifying the network the device is in by receiving network identification signals.

18. The method as recited in claim 10, wherein the step of permitting the operation to be performed includes notifying a user that information is available for retrieval and automatically retrieving the information upon establishment of communication with a user selected network.

19. The method as recited in claim 18, wherein the step of automatically retrieving includes assigning networks to operations in an order of priority such that if a first network is unavailable a next network is employed to perform the operation.
